(19) United States
(12) Patent Application Publication
(10) Pub. No.: US 2013/0312100 A1
(43) Pub. Date: Nov. 21, 2013

(54) ELECTRONIC DEVICE WITH VIRUS PREVENTION FUNCTION AND VIRUS PREVENTION METHOD THEREOF

(71) Applicants: Hon Hai Precision Industry Co., Ltd., New Taipei (TW); Fu Tai Hua Industry (Shenzhen) Co, Ltd., Shenzhen (CN)

(72) Inventor: PENG WANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/894,449

(22) Filed: May 15, 2013

(30) Foreign Application Priority Data
May 17, 2012 (CN) 2012101532872

(51) Int. Cl. G06F 21/56

(52) U.S. Cl. CPC G06F 21/56
USPC 726/24

(57) ABSTRACT

In a virus prevention method of an electronic device, executable files that are being installed in the electronic device are compared with the virus characteristics in virus database of the electronic device. The electronic device communicates with a server through a network, and a virus database and a suspected virus database of the server are accessed when one or more suspected files are determined. The one or more suspected files are compared with virus characteristics of virus samples in the virus database and non-viral characteristic of non-virus samples in the suspected virus database of the server, so as to determine whether the one or more suspected files are virus files. The determined one or more virus files intruded in the executed files are deleted.

### BACKGROUND

1. Technical Field

The present disclosure relates to computer virus prevention technologies, and particularly to an electronic device with virus prevention function and a virus prevention method.

2. Description of Related Art

A virus prevention system is usually employed in an electronic device, so as to prevent viruses affecting a network. Since a virus database of the electronic device is updated at intervals, such as every one or two days, the virus prevention system may not accurately and timely detect new type of viruses from the network intruding in executable files that have already been installed in the electronic device, or are being installed in the electronic device. Accordingly, the electronic device may be apt to be attacked by the new type of viruses from the network, resulting in unexpected losses for users.

Therefore, it is desirable to provide a means which can overcome the above-mentioned problems.

### BRIEF DESCRIPTION OF THE DRAWINGS

FIG. 1 is a schematic block diagram illustrating one embodiment of an electronic device including a virus prevention system.

FIG. 2 is a schematic diagram of the electronic device of FIG. 1 in communication with a server through a network.

FIG. 3 is a flowchart of one embodiment of a virus prevention method of the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

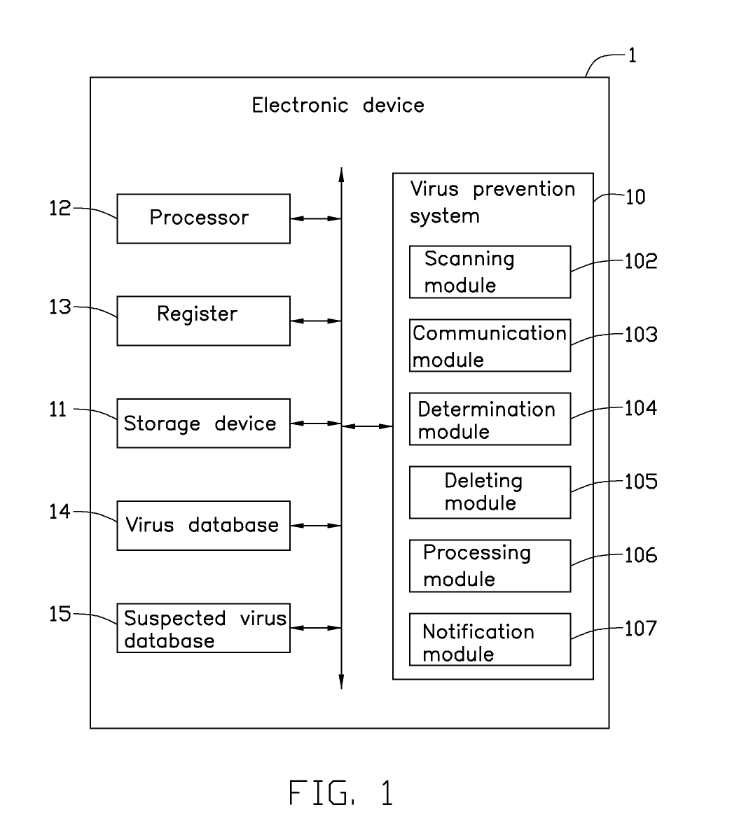

In FIG. 1, an electronic device 1 includes a virus prevention system 10, a storage device 11, at least one processor 12, a register 13, a virus database 14, and a suspected virus database 15. In one embodiment, the electronic device 1 may be, for example, a panel computer, a smart phone, a personal digital assistant, or other similar device. FIG. 1 is only one example of the electronic device 1, and the electronic device 1 may include more or fewer components than those shown in the embodiment, or have a different configuration of the components.

The virus database 14 includes virus characteristics of a plurality of electronic virus samples (e.g., computer viruses, malware, spyware). In the embodiment, the virus characteristics are computerized programs that include typical virus formats and encoding arrangements of the virus samples. Each of the virus samples includes a plurality of programs. The suspected virus database 15 includes encoding characteristics which resemble those of a virus but are non-viral, and which are apt to be mistaken for a virus in a plurality of predetermined non-viral samples. In the embodiment, each of the encoding characteristics includes a type and a name of a non-viral sample. The virus database 14 and the suspected virus database 15 are stored in the storage device 11.

The virus prevention system 10 may include a plurality of programs in the form of one or more computerized instructions stored in the storage device 11 and executed by the at least one processor 12 to perform operations of the electronic device 1. In the embodiment, the virus prevention system 10 includes a scanning module 102, a communication module 103, a determination module 104, a deleting module 105, a processing module 106, and a notification module 107. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The scanning module 102 scans executable files that are currently being installed to the electronic device 1 or that have already been installed in the electronic device 1, compares the executable files with the virus characteristics in the virus database 14 and the encoding characteristics in the suspected virus database 15, and determines whether the executable files includes one or more actual virus files and any suspected files. In the embodiment, when one or more virus files and/or one or more suspected files are detected in the executable files that are being installed to the electronic device 1, the scanning module 102 transfers and stores the detected one or more virus files and/or any suspected files into the register 13, accompanying with a process of installing of the executable files being opened. The scanning module 102 then continues to scan the other executable files that are subsequently opened. The suspected files are executable files that the scanning module 102 cannot determine whether they are virus files or not, according to the virus database 14 and the suspected virus database 15.

In detail, when the scanning module 102 detects that an executable file includes each computerized programs of a virus sample in the virus database 14, the scanning module 102 determines that the executable file is a virus file. When a scanning module 102 detects that an executable file includes at least part of the computerized programs of a virus sample in the virus database 14, the scanning module 102 compares the detected executable file with the encoding characteristics in the suspected virus database 15, and then determines that the detected executable file contains no virus file if the detected executable file matches with a type and a name of a non-viral sample in the suspected virus database 15. Otherwise, the detected executable file is determined as a suspected file if the detected executable file does not match with a type and a name of a non-viral sample in the suspected virus database 15. Likewise, all other executable files are scanned by the scanning module 102.

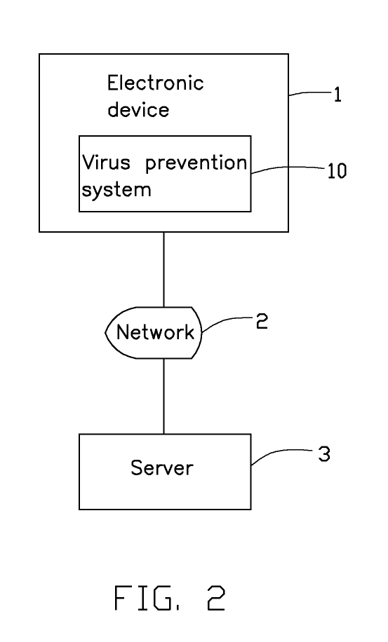

The communication module 103 establishes an electronic communication between the electronic device 1 and a server 3 via a network 2 (shown in FIG. 2) when a suspected file is detected, and accesses a virus database (not shown) and a suspected virus database (not shown) of the server 3. The network 2 may be a wired network or a wireless network, for example. The server 3 is provided by a vendor of virus prevention software. The virus prevention system 10 may be virus prevention software downloaded from the server 3 by a user. The virus database of the server 3 includes virus characteristics of a plurality of virus samples. The virus characteristics may be, computerized programs that include typical virus formats and encoding arrangements, for example. The suspected virus database of the server 3 includes encoding characteristics which resemble those of a virus but are non-viral, and which are apt to be mistaken for a virus in a plurality of non-viral samples. Each of the encoding characteristics stored in the suspected virus database of the server 3 may be, for example, a type and a name of a corresponding non-viral sample.

The determination module 104 compares the one or more detected suspected files with the virus characteristics of the virus database and the encoding characteristics of the suspected virus database of the server 3, and determines whether the one or more suspected files are virus files based on the comparison. In detail, when a detected suspected file includes all computerized programs of a virus sample in the virus database of the server 3, the determination module 104 determines that the detected suspected file is a virus file. When the detected suspected file matches with a type and a name of any of the non-viral samples in the suspected virus database of the server 3, the determination module 104 determines that the suspected file is a non-viral file.

The deleting module 105 deletes the virus files that are determined by the scanning module 102 and the determination module 104 from the electronic device 1.

The processing module 106 records the type and name of each of the detected one or more suspected files that are non-viral files determined by the determination module 104 into the suspected virus database 15. Additionally, for the executable files that are being installed in the electronic device 1, the processing module 106 further moves the one or more suspected files that are non-viral files determined by the determination module 104 from the register 13 to a corresponding directory of the storage device 11.

The notification module 107 notifies that the one or more virus files are deleted. Alternatively, the notification module 107 can be omitted.

Since the electronic device 1 with virus prevention function includes the communication module 103, the electronic device 1 can access to the server 3 when the scanning module 102 finds one or more suspected files. Thereupon, the electronic device 1 accesses to the virus database and the suspected virus database of the server 3 when the virus prevention system 10 scans the executable files that are being installed or that have been installed, compares the one or more suspected files found by the scanning module 102 with the virus samples in the virus database and non-viral samples in the suspected virus database of the server 3, and determines whether the one or more suspected files are virus files. Because the virus database and suspected virus database of the server 3 are updated in real-time, the virus prevention system 10 provided by the server 3 can find whether the executable files that are being installed and have been installed are attacked by new type of network viruses accurately and timely. Accordingly, data safe of the electronic device 1 is improved.

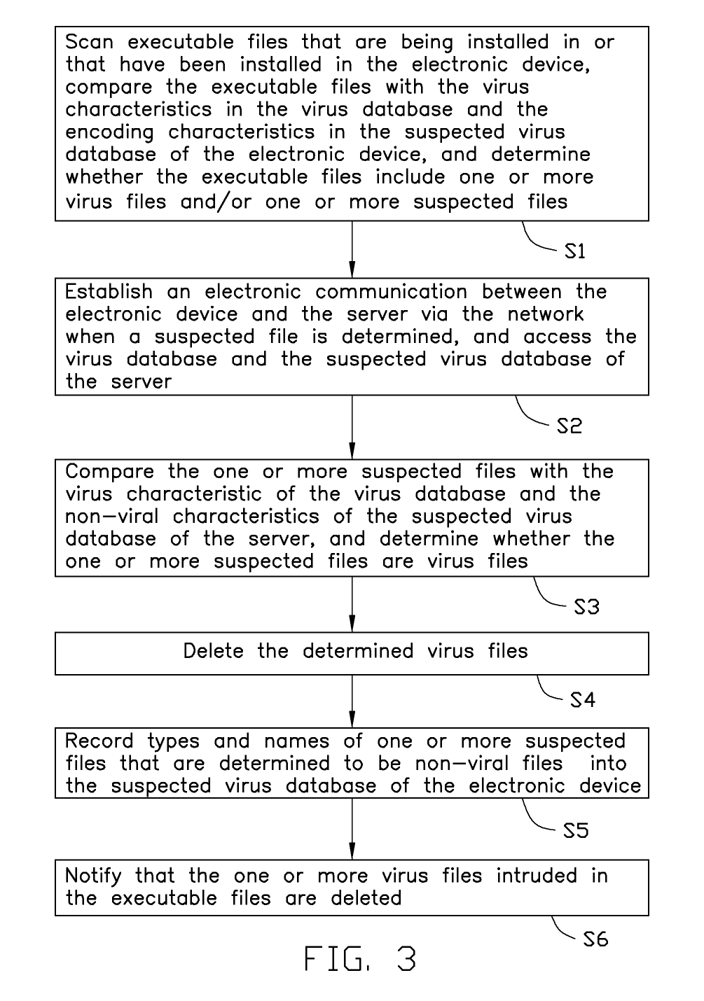

FIG. 3 is a flowchart of one embodiment of a virus prevention method of the electronic device 1 of FIG. 1. Depending on the embodiment, additional blocks may be added, others removed, and the ordering of the blocks may be changed.

In step S1, the scanning module 102 scans executable files that are being installed in the electronic device 1 or that have been installed in the electronic device 1, compares the executable files with the virus characteristics in the virus database 14 and the encoding characteristics in the suspected virus database 15, and determines whether the executable files include one or more virus files and one or more suspected files. In the embodiment, when one or more virus files and/or one or more suspected files are detected in the executable files that are being installed, the scanning module 102 transfers and stores the detected one or more virus files and/or the one or more suspected files into the register 13 accompanying with a process of installing of the executable files, and then continues to scan the other executable files.

In detail, when the scanning module 102 detects that an executable file includes each computerized program of a virus sample in the virus database 14, the scanning module 102 determines that the executable file is a virus file. When the scanning module 102 detects that an executable file includes partial computerized programs of a virus sample in the virus database 14, the scanning module 102 compares the detected executable file with encoding characteristics in the suspected virus database 15, and then determines that the detected executable file is non-viral file if the detected executable file matches with a type and a name of a non-viral sample in the suspected virus database 15. Otherwise, the detected executable file is determined as a suspected file if the detected executable file does not match with a type and a name of a non-viral sample in the suspected virus database 15. Likewise, other executable files are scanned by the scanning module 102.

In step S2, the communication module 103 establishes a communication between the electronic device 1 and the server 3 via the network 2 when a suspected file is detected, and accesses to the virus database and the suspected virus database of the server 3.

The virus database of the server 3 includes virus characteristics of a plurality of virus samples. The virus characteristics may be, codes, for example. The suspected virus database of the server 3 includes encoding characteristics of a plurality of non-viral samples that are apt to be mistaken as viruses. The encoding characteristics may be, types and names of the non-viral samples, for example.

In step S3, the determination module 104 compares the one or more suspected files with the virus characteristics of the virus database and the encoding characteristics of the suspected virus database of the server 3, and determines whether the one or more suspected files are virus files based on the comparison.

In detail, when a suspected file includes all computerized programs of a virus sample in the virus database of the server 3, the determination module 104 determines that the detected suspected file is a virus file. When the detected suspected file matches with a type and a name of any of the non-viral samples in the suspected virus database of the server 3, the determination module 104 determines that the suspected file is a non-viral file.

In step S4, the deleting module 105 deletes the virus files that are determined by the scanning module 102 and the determination module 104 from the electronic device 1.

In step S5, the processing module 106 records the type and name of each of the detected one or more suspected files that are non-viral files determined by the determination module 104 into the suspected virus database 15. Additionally, for the executable files that are being installed in the electronic device 1, the processing module 106 further moves the one or more suspected files that are non-viral files determined by the determination module 104 from the register 13 to the corresponding directory of the storage device 11.

In alternative embodiments, the virus prevention method further includes a step S6: the notification module 107 notifies that the one or more virus files are deleted.

The suspected virus database 15 may be omitted. Accordingly, the scanning module 102 only compares the executable files with the virus characteristics in the virus database 14, and determines that an executable file is a suspected file when the executable file includes all virus characteristics of a virus sample of the virus database 14. The determination module 104 further compares the suspect file with the virus database and the suspected virus database of the server 3, and determines whether the suspect file is a virus file.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A virus prevention method of an electronic device, the electronic device comprising a register, a virus database, and a suspected virus database, the virus database comprising virus characteristics of a plurality of virus samples, the suspected virus database comprising encoding characteristics which resemble those of a virus but are non-viral, the method comprising:
scanning executable files that are being installed in the electronic device, comparing the executable files with the virus characteristics in the virus database, and determining whether the executable files comprise one or more virus files and/or one or more suspected files;
establishing an electronic communication between the electronic device and a server via a network, and accessing a virus database and a suspected virus database of the server when one or more suspected files are determined;
comparing the determined one or more suspected files with virus characteristics of virus samples in the virus database and non-viral characteristics of non-virus samples in the suspected virus database of the server, and determining whether the one or more suspected files are virus files according to the comparison; and
deleting the determined one or more virus files intruded in the executed files.

2. The method according to claim 1, further comprising:
notifying that the one or more virus files intruded in the executed files are deleted.

3. The method according to claim 1, further comprising:
comparing the determined one or more suspected files with the encoding characteristics in the suspected virus database of the electronic device, during the step of scanning executable files, and determining whether the determined one or more suspected files are virus files.

4. The method according to claim 3, further comprising:
transferring the determined one or more suspected files into the register, when one or more suspected files are determined during the step of scanning the executable files, such that the determined one or more suspected files are not installed in an installation path of the executable files; and
installing one or more suspected files that are determined to be non-viral virus files in the register to the installation path of the executable files.

5. The method according to claim 4, further comprising:
recording the one or more suspected files that are determined to be non-viral virus files in the register to the suspected virus database of the electronic device.

6. An electronic device, comprising:
a register;
a virus database comprising virus characteristics of a plurality of virus samples;
a storage device;
at least one processor; and
one or more programs stored in the storage device and executed by the at least one processor, the one or more programs comprising:
a scanning module scanning executable files that are being installed in the electronic device, comparing the executable files with the virus characteristics in the virus database, and determining whether the executable files comprise one or more virus files and/or one or more suspected files;
a communication module establishing an electronic communication between the electronic device and a server via a network, and accessing a virus database and a suspected virus database of the server when one or more suspected files are determined;
a determination module comparing the one or more suspected files determined by the scanning module with virus characteristics of virus samples in the virus database and non-viral characteristic of non-virus samples in the suspected virus database of the server, and determining whether the determined one or more suspected files are virus files; and
a deleting module deleting the determined one or more virus files intruded in the executed files.

7. The electronic device according to claim 6, wherein the one or more programs further comprise a notification module, the notification module notifies that the one or more virus files intruded in the executed files are deleted.

8. The electronic device according to claim 6, further comprising a suspected virus database, wherein the suspected virus database of the electronic device comprisies encoding characteristics which resemble those of a virus but are non-viral, the scanning module further compares the determined one or more suspected files with the encoding characteristics in the suspected virus database of the electronic device during scanning executable files, and determines whether the determined one or more suspected files are virus files.

9. The electronic device according to claim 8, wherein the one or more programs further comprise a processing module, the processing module transfers the one or more suspected files determined by the scanning module into the register, such that the determined one or more suspected files are not installed in an installation path of the executable files, and installs one or more suspected files that are non-viral files determined by the determination module in the register to an installation path of the executable files.

10. The electronic device according to claim 9, wherein the processing module further records the one or more suspected files that are non-viral files determined by the determination module in the register to the suspected virus database of the electronic device.

11. A virus prevention method of an electronic device, the electronic device comprising a register, a virus database, and a suspected virus database, the virus database comprising virus characteristics of a plurality of virus samples, the suspected virus database comprising encoding characteristics which resemble those of a virus but are non-viral, the method comprising:
scanning executable files that have been installed in the electronic device, comparing the executable files with the virus characteristics in the virus database, and determining whether the executable files comprise one or more viruses and/or one or more suspected files;
establishing an electronic communication between the electronic device and a server via a network, and accessing a virus database and a suspected virus database of the server when one or more suspected files are determined;
comparing the determined one or more suspected files with virus characteristics of virus samples in the virus database and non-viral characteristic of non-virus samples in the suspected virus database of the server, and determining whether the determined one or more suspected files are virus files; and
deleting the determined one or more virus files intruded in the executed files.

12. The method according to claim 11, further comprising:
notifying that the one or more virus files intruded in the executed files are deleted.

13. The method according to claim 11, further comprising:
comparing the determined one or more suspected files with the encoding characteristics in the suspected virus database of the electronic device during the step of scanning executable files, and determining whether the determined one or more suspected files are virus files.

14. The method according to claim 13, further comprising:
recording the one or more suspected files that are determined to be non-viral virus files in the register to the suspected virus database of the electronic device.
